(19) United States
(12) Patent Application Publication
(10) Pub. No.: US 2026/0259051 A1
(43) Pub. Date: Sep. 3, 2026

(54) SLIT-CUT RESONATOR FOR A VIBRATORY GYROSCOPE

(71) Applicant: HRL Laboratories, LLC, Malibu, CA (US)

(72) Inventors: Lianxin HUANG, Malibu, CA (US); Logan SORENSON, Malibu, CA (US); Matthew PELLICCIONE, Malibu, CA (US); David CHANG, Malibu, CA (US)

(73) Assignee: HRL Laboratories, LLC, Malibu, CA (US)

(21) Appl. No.: 19/243,523

(22) Filed: Jun. 19, 2025

Related U.S. Application Data
(60) Provisional application No. 63/765,272, filed on Feb. 28, 2025.

(51) Int. Cl. G01C 19/5712

(52) U.S. Cl. CPC G01C 19/5712

(57) ABSTRACT

A resonant structure comprising at least two coaxial rings attached together by a plurality of connection structures regularly arranged along their peripheries; wherein a first ring has a first ring portion with a first radial thickness and a second ring portion formed by a first radial recess developing from a periphery of the first ring distal from the first connection structure toward the first connection structure; wherein the first ring portion comprises two second radial recesses arranged symmetrically with respect to the second ring portion, each of the two second radial recesses having a rectangular portion that develops radially from a periphery of the first ring that is in contact with the first connection structure; wherein a sum of the radial length of the first radial recess and the radial length of any of the two second radial recesses is larger than the first radial thickness.

### CROSS-REFERENCE TO RELATED APPLICATIONS

This presentation is related to U.S. provisional Application No. 62/555,617 filed Sep. 7, 2017, which is hereby incorporated by reference in its entirety. This presentation is related to U.S. Non-Provisional application Ser. No. 16/102,565 filed Aug. 13, 2018, which is hereby incorporated by reference in its entirety.

This presentation claims priority to and benefit of U.S. provisional Application No. 63/765,272, filed on Feb. 28, 2025 and entitled “SLIT-CUT RESONATOR FOR A VIBRATORY GYROSCOPE”, which is hereby incorporated by reference in its entirety.

### TECHNICAL FIELD

This presentation relates to MEMS Disk Resonator Gyroscopes, and in particular relates to the disk resonators of Coriolis Vibratory Gyroscopes.

### BACKGROUND

Disc Resonator Gyroscopes are described for example in U.S. Pat. No. 7,581,443, which is hereby incorporated by reference in its entirety. FIG. 1 illustrates a perspective view and a detailed fragment of a perspective view of a portion of a known disc resonator 10 architecture for an all-quartz or all silicon resonator gyroscope. Resonator 10 can be fabricated out of a fused quartz or silicon plane disc in which deep reactive ion etching may be used to etch the disc into a system of adjacent coaxial rings 12 supported at a central support 14; adjacent coaxial rings 12 having adjacent peripheries 13 and being attached together by a plurality of connection structures 16 regularly arranged along said adjacent peripheries.

A problem of known resonator 10 is that vibratory gyroscopes using such resonators are sensitive to vibration, shock, and temperature. With known vibratory gyroscope designs, especially disk resonator gyroscopes having a resonator such as 10 with a plurality of interconnected concentric rings 12, reducing the width of ring 12 reduces the resonator's stiffness and this results in a lower resonance frequency, thus improving the tuning capability of the resonator (which allows for example to accommodate a temperature induced drift) but also at the same time making the resonator more susceptible to environmental vibrations and/or shocks.

Hinge Slot-cut Vibratory Gyroscope (HSVG) resonators such as disclosed in U.S. application Ser. No. 16/102,565 solve some of these problems, but the Inventors have noted that HSVG resonators may be difficult to manufacture, due to a large hinge circle that creates a larger loading effect during deep silicon etching. The Inventors have noted that more etching gas goes in the larger opening area, etching faster than the nearby slot and creates a difficult to control, non-uniform, etching across the device.

There exists a need for a design of a resonator for a disk resonator gyroscope having improved tuning capability as well as low sensitivity to vibration and shock, that is easier to manufacture than the HSVG resonator as described in U.S. application Ser. No. 16/102,565.

### SUMMARY

This presentation relates to resonators or resonant structures, such as for a disk resonator gyroscope, having concentric rings attached to each other by specific “Hinge and/or Slot” connection structures wherein the width of the rings is reduced in the vicinity of the connection structures, such design making the resonators less sensitive to vibration and shock compared to known resonators having rings of the same width but having no “Hinge and/or Slot” connection structures.

This presentation relates to resonators that comprise a rotationally-symmetric array of slit-cut joint design connecting rings. According to some embodiments, the slit-cut joint has two rectangle cuts with an angular width equal to the slot width (width between two consecutive rings), and optionally two slot cuts on the two sides of the joint (top and bottom edge of the joint), as for example illustrated in FIGS. 2, 3, 4, 7a). According to some embodiments, the rectangle cuts have circular ends. The circular ends of the cuts can have a diameter larger than, equal to, or smaller than the slit-cut angular width.

According to some embodiments and as for example illustrated in FIG. 7b, the slit-cut joint has two rectangle cuts with circular ends with each an angular width greater than the width of the slot/space between the rings, and optionally two slot cuts on the two sides of the joint (top and bottom edge of the joint).

According to some embodiments and as for example illustrated in FIG. 7c, the slit-cut joint has two rectangle cuts with circular ends with each an angular width less than the width of the slot/space between the rings, and optionally two slot cuts on the two sides of the joint (top and bottom edge of the joint).

According to some embodiments and as for example illustrated in FIGS. 7d and 7e, the slit-cut joint has more than two rectangle cuts with circular ends with each an angular width equal to or greater than the width of the slot/space between the rings, and optionally two slot cuts on the two sides of the joint (top and bottom edge of the joint).

According to some embodiments and as for example illustrated in FIG. 7f, the slit-cut joint additionally comprises more than two outside rectangle cuts with circular ends, each with an angular width greater than the width of the slot/space between the rings, and optionally two slot cuts on the two sides of the joint (top and bottom edge of the joint).

According to some embodiments and as for example illustrated in FIG. 7g, the slit-cut joint has more than two “serpentine” rectangle cuts (i.e. an alternating arrangement of one radial cut developing inward from an outward periphery of the ring and one radial cut developing outward from an inward periphery of the ring) with circular ends, each cut having an angular width greater than or equal to the width of the slot/space between the attached rings, and optionally two slot cuts on the two sides of the joint (top and bottom edge of the joint).

Some embodiments, as for example shown in FIG. 4, also comprise a gyroscope with a resonator as detailed in this application, arranged such that the outward-most periphery of the outward-most ring of the resonator is surrounded by a plurality of peripheral, capacitive, electrodes.

According to some embodiments, as for example shown in FIG. 5, the resonator is fabricated on Silicon On Insulator (SOI) wafers.

As for example illustrated in FIGS. 2, 3, 4, 6, 7a to 7g, embodiments of this presentation include a resonant structure comprising at least two coaxial rings, wherein: adjacent coaxial rings have adjacent peripheries and are attached together by a first plurality of connection structures regularly arranged along the adjacent peripheries; and a first ring of said at least two rings has a first ring portion with a first radial thickness and a second ring portion, in a vicinity of a first connection structure, with a second radial thickness smaller than the first radial thickness; wherein the second ring portion is formed by a first radial recess developing from a periphery of the first ring distal from the first connection structure toward the first connection structure; wherein the first ring portion comprises at least two second radial recesses of identical radial lengths and arranged symmetrically with respect to the second ring portion, each of the at least two second radial recesses having at least a rectangular portion that develops radially from a periphery of the first ring that is in contact with the first connection structure; and wherein a sum of the radial length of the first radial recess and the radial length of any of the at least two second radial recesses is larger than the first radial thickness.

Other embodiments of this presentation include a method of manufacturing a resonant structure comprising providing at least two coaxial rings, wherein: adjacent coaxial rings have adjacent peripheries and are attached together by a plurality of connection structures regularly arranged along the adjacent peripheries; and a first ring of said at least two rings has a first ring portion with a first radial thickness and a second ring portion, in a vicinity of a first connection structure, with a second radial thickness smaller than the first radial thickness; wherein the second ring portion is formed by a first radial recess developing from a periphery of the first ring distal from the first connection structure toward the first connection structure; wherein the first ring portion comprises at least two second radial recesses of identical radial lengths and arranged symmetrically with respect to the second ring portion, each of the at least two second radial recesses having at least a rectangular portion that develops radially from a periphery of the first ring that is in contact with the first connection structure; and wherein a sum of the radial length of the first radial recess and the radial length of any of the at least two second radial recesses is larger than the first radial thickness.

As for example illustrated in FIG. 7d, according to embodiments of this presentation, the at least two second radial recesses comprise two pairs of second radial recesses arranged symmetrically with respect to the second ring portion.

As for example illustrated in FIG. 7e, according to embodiments of this presentation the at least two second radial recesses comprise more than two pairs of second radial recesses arranged symmetrically with respect to the second ring portion.

As for example illustrated in FIGS. 7f and 7g, according to embodiments of this presentation the first ring portion additionally comprises at least two third radial recesses, optionally of identical radial lengths, arranged symmetrically with respect to the second ring portion, each of the at least two third radial recesses having at least a rectangular portion that develops radially from the periphery of the first ring that is distal from said first connection structure.

As for example illustrated in FIGS. 7f and 7g, according to embodiments of this presentation, a sum of the radial length of any of the at least two second radial recesses and the radial length of any of the at least two third radial recesses is larger than the first radial thickness.

As for example illustrated in FIGS. 7f and 7g, according to embodiments of this presentation, at least two of the at least two second radial recesses are arranged each between the first radial recess and one of the at least two third radial recesses.

As for example illustrated in FIGS. 7b and 7c, according to embodiments of this presentation, the first radial recess and the at least two second radial recesses have different angular widths.

As for example illustrated in FIG. 7c, according to embodiments of this presentation the first radial recess has a larger angular width than any of the at least two second radial recesses.

As for example illustrated in FIG. 7b, according to embodiments of this presentation the first radial recess has a smaller angular width than any of the at least two second radial recesses.

According to embodiments of this presentation, the at least two coaxial rings and the plurality of connection structures are formed out of a single plane substrate; for example a SOI substrate.

According to embodiments of this presentation, the first ring portion has a radial axis of symmetry that is aligned with a radial axis of symmetry of the first connection structure.

According to embodiments of this presentation, the periphery of the first ring, in the second ring portion, follows, along a plane perpendicular to the axis of the rings, portions of a shape selected among: a circle; an ellipse; and a rectangle.

As for example illustrated in FIGS. 2, 3, 4, 6 and 7a to 7g, according to embodiments of this presentation the at least two coaxial rings further comprise a second ring coaxially attached to the first ring by the first plurality of connection structures; and third and fourth coaxial rings attached together by a second plurality of connection structures being radially aligned each with a connection structure of the first plurality of connection structures; wherein the third ring has a third ring portion having a third radial thickness and has a fourth ring portion having a fourth radial thickness smaller than the third radial thickness; the fourth ring portion being radially aligned with the second ring portion; the fourth ring portion being formed by a third radial recess, developing from a periphery of the third ring distal from a second connection structure of the second plurality of connection structures toward the second connection structure; wherein the third ring portion comprises at least two fourth radial recesses of identical radial lengths and arranged symmetrically with respect to the fourth ring portion, each of the at least two fourth radial recesses having at least a rectangular portion that develops radially from a periphery of the third ring that is in contact with the second connection structure; and wherein a sum of the radial length of the third radial recess and the radial length of any of the at least two fourth radial recesses is larger than the second radial thickness.

According to embodiments of this presentation, one of the first and second rings is attached to one of the third and fourth rings by a plurality of regularly arranged third connection structures angularly offset from the first connection structures attaching the first and second rings.

According to embodiments of this presentation, a same number N of connection structures attach each ring to a neighboring ring; and connection structures attached to an inner and an outer periphery of each ring are angularly offset by π/N from each other.

As for example illustrated in FIGS. 2, 3, 4, 6 and 7a to 7g, according to embodiments of this presentation the at least two coaxial rings comprise a second ring coaxially attached to the first ring by the first connection structure; wherein the second ring has a third ring portion having a third radial thickness and has a fourth ring portion having a fourth radial thickness smaller than the third radial thickness; the fourth ring portion being radially aligned with the second ring portion; the fourth ring portion being formed by a third radial recess developing from a periphery of the second ring distal from the first connection structure toward the first connection structure; wherein the third ring portion comprises at least two fourth radial recesses of identical radial lengths and arranged symmetrically with respect to the fourth ring portion, each of the at least two fourth radial recesses having at least a rectangular portion that develops radially from a periphery of the second ring that is in contact with the first connection structure; and wherein a sum of the radial length of the third radial recess and the radial length of any of the at least two fourth radial recesses is larger than the second radial thickness.

According to embodiments of this presentation, the at least two coaxial rings comprise at least three coaxial rings, wherein a distance between two consecutive coaxial rings is constant.

According to embodiments of this presentation, the at least two coaxial rings comprise at least three coaxial rings, wherein a distance between two consecutive coaxial rings varies radially.

According to embodiments of this presentation, the innermost of the at least two coaxial rings is attached, using connection structures similar to those described previously, to a pillar having a same axis as the at least two coaxial rings.

As for example illustrated in FIGS. 7a and 7d to 7g, according to embodiments of this presentation the at least two second radial recesses have each an angular width that is equal to a distance between the at least two adjacent rings.

According to embodiments of this presentation, the first radial recess is optional, and the radial length of any of the at least two second radial recesses is smaller than the first radial thickness.

According to embodiments of this presentation, the first radial recess and any of the at least two second radial recesses have a rounded end in a plane parallel to the plane of the rings.

According to embodiments of this presentation, the outermost of the at least two coaxial rings comprises no first radial recess, so as to allow a stronger interaction between an outermost surface of the outermost ring and capacitive electrodes arranged at a distance of said outermost surface.

Other embodiments of this presentation relate to methods of manufacturing of the above-recited resonators.

These and other features and advantages will become further apparent from the detailed description and accompanying figures that follow. In the figures and description, numerals indicate the various features; like numerals referring to like features throughout both the drawings and the description.

### BRIEF DESCRIPTION OF THE DRAWINGS

FIG. 1 shows a picture of a fragment of a known Coriolis Vibratory Gyroscope (CVG) resonator, as well as a very detailed view of a fragment of the CVG resonator.

FIG. 2 illustrates a top view of a resonator according to an embodiment of this presentation, together with a first enlargement of a section of the resonator, together with an enlargement of the first enlargement.

FIG. 3 illustrates a projection view of a resonator according to an embodiment of this presentation, together with an enlargement of a section of the resonator.

FIG. 4 illustrates a top view of a gyroscope using a resonator according to an embodiment of this presentation, together with a first enlargement of a section of the gyroscope, together with an enlargement of the first enlargement.

FIG. 5 illustrates four steps of fabrication of a gyroscope according to embodiments of this presentation.

FIG. 6 is a graph illustrating the performances of a gyroscope according to this presentation compared to the performances of known gyroscopes.

FIGS. 7A to 7G show the detail of two discs portions attached by a connection structure according to various embodiments of a resonator according to this presentation.

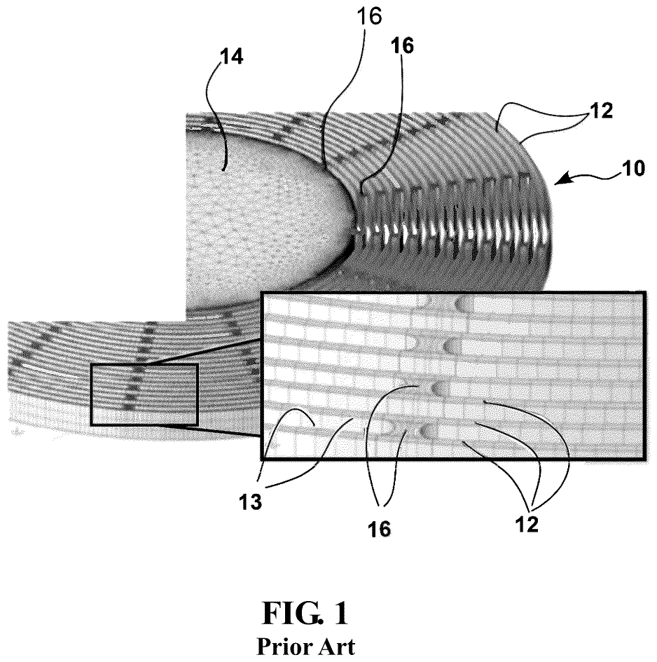

### DESCRIPTION

In the following description, numerous specific details are set forth to clearly describe various specific embodiments disclosed herein. One skilled in the art, however, will understand that the presently described invention may be practiced without all of the specific details discussed below. In other instances, well known features have not been described so as not to obscure the invention.

The Inventors have conducted finite element analysis COMSOL models with thermoelastic damping, and have come to the conclusion that a critical location of energy loss of the known Disc Resonator of Disc Resonator Gyroscopes, is at the joint between the rings of the Resonator.

The present disclosure improves MEMS gyroscope having concentric rings attached together by joints, (or connection structures) by making the joints between the rings as compliant as the remaining portions of the rings, without reducing the resonance frequency of the resonator.

U.S. Pat. No. 7,581,443 describes Disc Resonator Gyroscopes (DRGs). Slit Cut Vibratory Gyroscopes (SCVG) according to this presentation improve upon DRGs by operating at similar frequencies with higher Q factors. DRGs are sensitive to vibration, shock, and temperature whereas a SCVG according to this presentation is significantly less sensitive to vibration and shock, and its tuning capability means that it can be tuned to accommodate a large array of temperature induced drift.

The Inventors have noted that in a state of the art MEMS vibratory gyroscope, especially a disk resonator gyroscope, reducing the ring width will reduce structure stiffness dramatically, resulting in a lower resonance frequency, making the resonator more susceptible to vibration environment. However, using a finite element analysis COMSOL model with thermo-elastic damping, the Inventors have found that a critical location of energy loss in the state of the art Disc Resonator Gyroscopes is at the joint between the rings. SCVGs using resonators according to this presentation satisfy a long felt-need for high performance inertial navigation in smaller packages with lower cost, weight, and power.

Embodiments of this presentation entail the design of a high-Q (Quality Factor) MEMS silicon Slit Cut Vibratory Gyroscope (SCVG), in particular of a resonator of such a SCVG. A Slit Cut vibratory resonator design according to embodiments of this presentation allows in-plane deformation of its structure without twisting to reduce strain-induced thermal gradients, resulting in high thermo-elastic damping limited quality factor (QTED >100,000). In particular, a Slit Cut design according to embodiments of this presentation enables reducing stiffness of joints/interconnections between rings while maintaining wider ring width (15-40 um), thus minimizing heat loss regions at the joint between the rings to increase thermo-elastic damping limited quality factor (QTED). Maintaining wider ring width allows diminishing surface roughness effect on both quality factor and frequency split between the two degenerate N=2 modes used for vibratory gyroscope operation. Slit Cut Vibratory Gyroscopes with thicknesses of 200 um (micrometers) or more have reduced acceleration sensitivity (up to 50,000 G) in any acceleration direction. By increasing the ring width for the whole structure, the Slit Cut Vibratory Gyroscopes design will have high adiabatic QTED since wider ring width (>100 um) will have frequency >100 kHz. Hence, a Slit Cut Vibratory Gyroscope design according to this presentation, in addition to particular implementations, can be thought of as a method to design high-Q silicon vibratory gyroscope and resonator structures in frequency ranges where this was previously not possible.

Embodiments of this presentation enable designing high-Q MEMS silicon Coriolis Vibratory Gyroscopes (CVGs). Current state of the art (SOA) CVGs include silicon disk resonator gyroscopes (DRGs) exhibiting resonance frequencies around 14 kHz and Q-factors upward of 80,000. A SCVG according to embodiments of this presentation has similar resonance frequency but with QTED >1.5X of SOA DRG. Embodiments of this presentation improve over previous HSVG designs, such as shown in U.S. application Ser. No. 16/102,565, by incorporating T-slots that serve the purpose of the previously circular hinges while simultaneously being better in terms of manufacturing by maintaining a relatively more uniform slot width compared with the HSVG design. The SCVG design according to embodiments of this presentation has the advantage of being both stiffer (more robust to environment) and having QTED over both the HSVG design and prior simple DRG designs (with the absence of either the slit cuts or hinges & slot cuts in the connection regions between adjacent rings), providing performance advantages for gyroscope operation.

Embodiments of this presentation allow manufacturing environmentally-robust, high-performance inertial sensors with attractive cost, size, weight, and power for applications in defense, space, security, commercial aircraft, automobile vehicle safety and dynamics, autonomous navigation, and emergency location services. Embodiments of this presentation can be realized using known wafer based fabrication techniques.

A SCVG according to embodiments of this presentation achieves high thermal elastic damping and anchor quality factor (QTED and Qanchor), low acceleration sensitivity, high frequency tuning range and higher frequency than state of the art Disk Resonator Gyroscopes (~10-15 kHz). A SCVG according to embodiments of this presentation comprises an anchor, rings, hinges/connection structures and slit-cuts in the rings and hinges/connection structures. The anchor can be a solid cylinder at the center of the resonator. According to embodiments, the resonator has uniform ring width except in the vicinity of the interconnection between rings. The resonator can have a uniform slot width between the rings. Alternatively, the resonator can have a gradient slot width, where the slot width between two consecutive rings varies from outer-most ring to anchor. The slit(s) in the resonator rings and hinges can be created by rectangle cut(s) having an angular width equal to the slot width (the width between the rings in which the slits are made). The (radial) length of each slit is less than the width of a ring in which it is formed. According to embodiments of this presentation, there are two additional slit cuts on the top and bottom side of the interconnector/hinge/connection structure for additional strain relief and thermal flux mitigation.

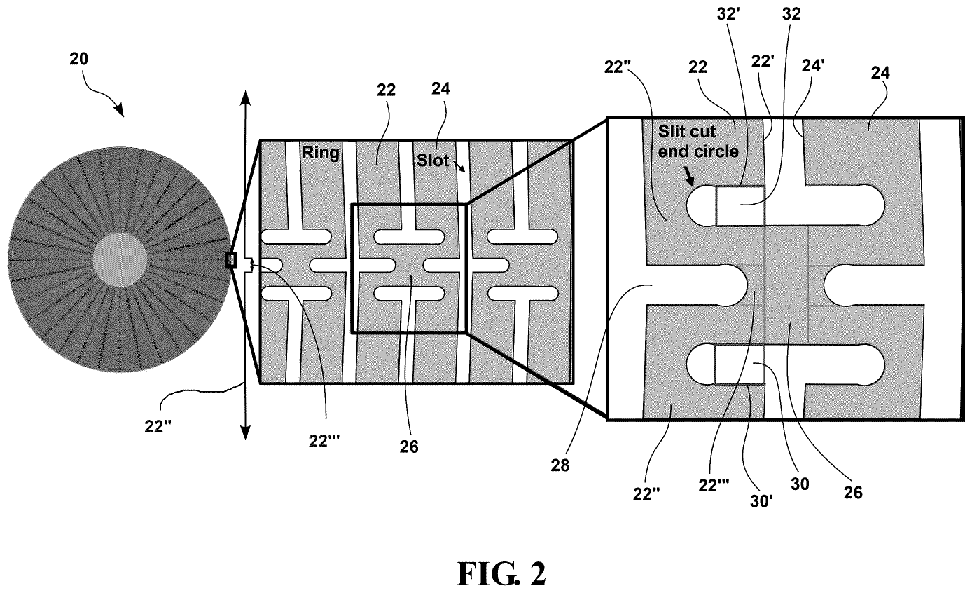

FIG. 2 illustrates schematically a top view of a resonator of a SCVG according to embodiments of this presentation, the resonator having an 8 mm outer diameter and 2 mm anchor diameter, 50-150 rings having each a 10-50 um ring (radial) width, separated by a 10-20 um slot (radial) width. The slit cut length, including the length of opposed slits in two consecutive rings plus the slot width, is of 20-100 um. The angular length of each connection structure is 20-60 um. The thickness of the resonator substrate may be greater than 200 um. The resonator comprises two types of slit cuts: (1) center slit cuts at top and bottom of connector/connection structure and (2) slit cuts at the left and right of the connector. In other words, a resonant structure 20 according to embodiments of this presentation comprises at least two coaxial rings 22, 24, wherein adjacent coaxial rings 22, 24 have adjacent peripheries 22′, 24′ and are attached together by a plurality of connection structures 26 regularly arranged along said adjacent peripheries 22′, 24′. A first ring 22 is mostly comprised of a first, larger, ring portion 22″ with a first radial thickness. Ring 22 also comprise a second, smaller, ring portion 22′″, in a vicinity of a first connection structure 26, with a second radial thickness smaller than the first radial thickness, wherein said second ring portion 22′″ is formed by a first radial recess 28 developing from a periphery of said first ring 22 that is distal from first connection structure 26, toward first connection structure 26. Further, first ring portion 22″ comprises in the vicinity of recess 28 at least two second radial recesses 30, 32 of identical radial lengths and arranged symmetrically with respect to second ring portion 22′″. Each of the at least two second radial recesses 30, 32 has at least a rectangular recess portion 30′, 32′ that develops radially from periphery 22′ of the first ring 22 (that is in contact with first connection structure 26). A sum of the radial length of first radial recess 28 and the radial length of any of the second radial recesses 30, 32 is larger than the radial thickness of the first ring 22.

The Inventors have shown that the above design has rings joined with more compliant connectors than in known resonators. Further, as outlined above, the large hinge circle of HSVG as disclosed in U.S. application Ser. No. 16/102,565 gives larger loading effect during deep silicon etching, which means that more etch gas goes in the larger opening area, etching faster than in the nearby slot. Hence, the large hinge circle of HSVG cause non-uniform etching across the device. A resonator according to embodiments of this presentation has more uniform opening across the device since the slit cut width is the same as the slot width, or similar. Hence, the etching process used for creating a resonator according to embodiments of this presentation is more uniform and allows creating more symmetric devices, that have reduced frequency split and Q-factor split. As a note, the radius of slit cut end circle when designed can be bigger or smaller than the slit cut width based on fabrication tolerances.

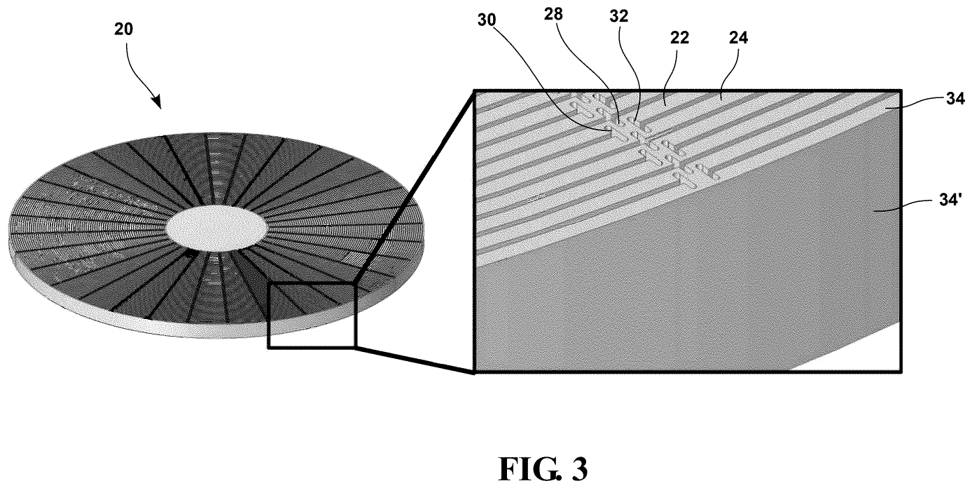

FIG. 3 shows an isometric view of resonator 20. In this figure, the center slit cut (cut 28 in ring 22) is removed from the outer-most ring 34 to maximize the electrical sensing area presented by the outer peripheral surface 34′ of ring 34, for higher signal to noise ratio if variations of the position of surface 34′ are to be detected using a capacitive electrode (not shown in FIG. 3).

According to embodiments of this presentation, varying the width, length and number of the slit-cuts can be used to optimize performance for each ring width, resulting in optimized geometry for different frequency operational range applications.

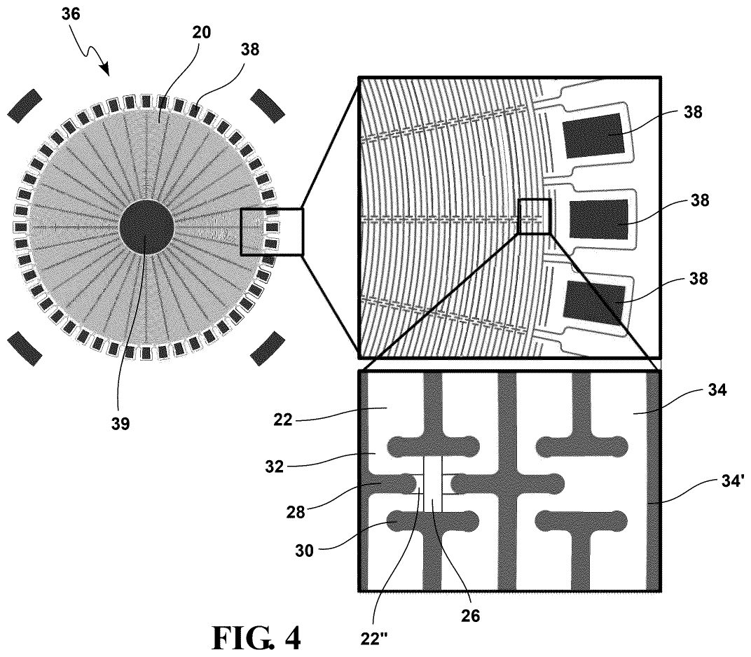

FIG. 4 is a schematic top view of a SCVG 36 using a resonator 20 according to embodiments of this presentation. The Gyroscope 36 comprises resonator 20 as well as peripheral electrodes 38. Electrodes 38 do not contact the resonator 20. Electrodes 38 can be wire bonded to control circuits (not shown). They are arranged to form a capacitor with the outer periphery surface 34′ of the outermost ring 34 of resonator 20, whereby a change in the measured capacitor indicates a motion of ring 34. In the embodiment illustrated in FIG. 4, the slit cuts 28, 30, 32 are rounded at all corners. Such rounding will reduce stress concentrations. FIG. 4 also shows different slit end circle radius compared to FIG. 2. An electrode 39 can be formed on the central post/support of resonator 20 to allow wire bonding to polarize/bias the resonator 20.

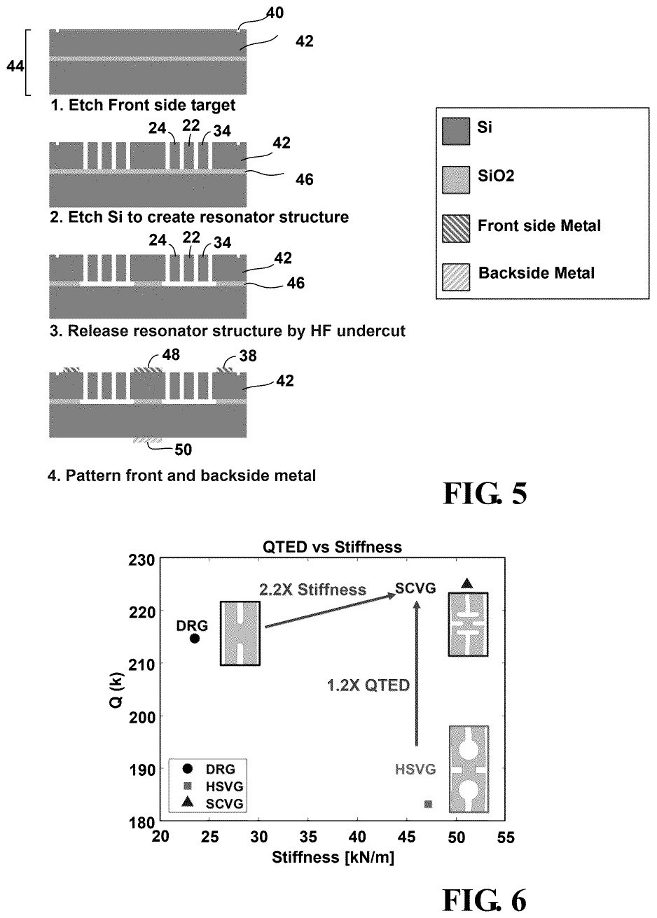

FIG. 5 illustrate steps of a fabrication process for a gyroscope such as gyroscope 36. First, a front alignment target 40 is formed by etching the surface of a top Si layer 42 of a SOI wafer 44. Second, the structure of resonator 20 is formed, for example by Deep Reactive-Ion Etching or DRIE) of the rings (22, 24, 34, . . . ) and their support and connection structures, in the Si layer 42. Third, the buried oxide 46 of wafer 44 is undercut for example using HydroFluoric (HF) acid to release a portion of the structure (rings) defined in step two. Fourth, front side metal 48 is patterned for electrical contact (including electrodes 38) on the front of the SOI wafer 42, following by backside metal 50 for die attachment to an LCC package.

A gyroscope using a resonator according to this presentation has better gyro performance than the state of the art Disk Resonator Gyroscopes (SOA DRG) such as shown in U.S. Pat. No. 7,581,443 or the Hinge Slot-cut Vibratory Gyroscopes (HSVG) disclosed in U.S. application Ser. No. 16/102,565, in terms of quality factor thermo-elastic damping quality (QTED), stiffness and fabrication tolerance.

FIG. 6 shows that a gyroscope according to this presentation (SCVG) achieves quality factor (Q) of 225,000(2.25E5), which is 1.2X of HSVG while comparable to SOA DRG. SCVG is 2.1X stiffer than SOA DRG while comparable of HSVG. The blue triangle marks the QTED vs stiffness for the embodiment SCVG design. Circles represent possible DRG designs with the black circle marking the SOA DRG design. Higher stiffness means less susceptibility to environmental vibration during operation. Higher QTED means higher sensitivity and lower gyro bias.

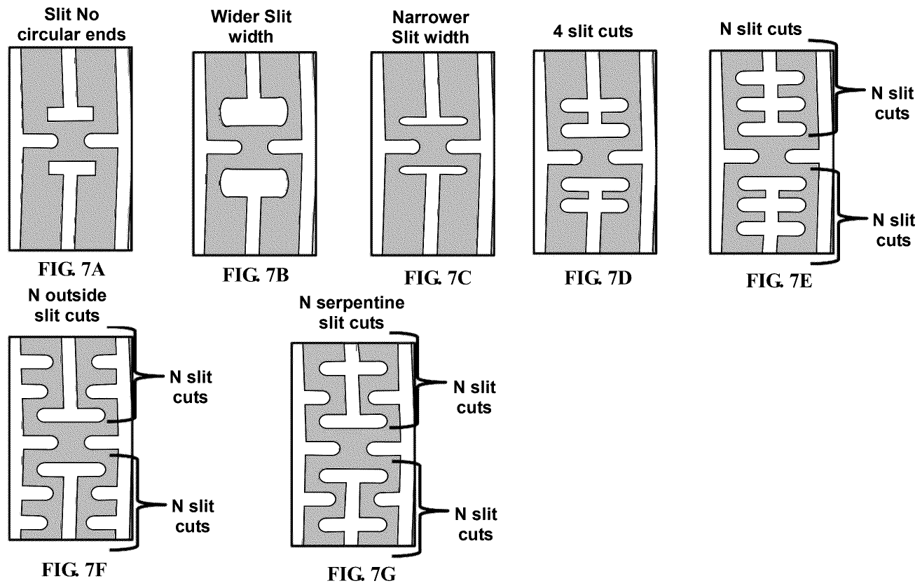

FIG. 7A to 7G show other SCVG variations: FIG. 7A: resonator with slit cuts with no circular ends, FIG. 7B: resonator with slit cut width wider than slot width, FIG. 7C: resonator with slit cut width narrower than slot width, FIG. 7D: resonator with four slit cuts, FIG. 7E: resonator with N slit cuts, FIG. 7F: resonator with N outside slit cuts, and FIG. 7G: resonator with N serpentine slit cuts. Ring width, Slot Width, Slit-cut width, Slit-cut length, Rounding radius of slit cut, ring number, slot space, inner and outer diameter are the key design parameters to understand in relationship to quality factor, acceleration sensitivity, and frequency tunability of MEMS gyroscopes.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art.

No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art.

What is claimed is:

1. A resonant structure comprising at least two coaxial rings, wherein: adjacent coaxial rings have adjacent peripheries and are attached together by a first plurality of connection structures regularly arranged along the adjacent peripheries; and a first of said rings has a first ring portion with a first radial thickness and a second ring portion, in a vicinity of a first connection structure, with a second radial thickness smaller than the first radial thickness; wherein the second ring portion is formed by a first radial recess developing from a periphery of the first ring distal from the first connection structure toward the first connection structure; wherein the first ring portion comprises at least two second radial recesses of identical radial lengths and arranged symmetrically with respect to the second ring portion, each of the at least two second radial recesses having at least a rectangular portion that develops radially from a periphery of the first ring that is in contact with the first connection structure; and wherein a sum of a radial length of the first radial recess and the radial length of any of the at least two second radial recesses is larger than the first radial thickness.

2. The resonant structure of claim 1, where the at least two second radial recesses comprise two pairs of second radial recesses arranged symmetrically with respect to the second ring portion.

3. The resonant structure of claim 2, where the at least two second radial recesses comprise more than two pairs of second radial recesses arranged symmetrically with respect to the second ring portion.

4. The resonant structure of claim 1, where the first ring portion additionally comprises at least two third radial recesses arranged symmetrically with respect to the second ring portion, each of the at least two third radial recesses having at least a rectangular portion that develops radially from the periphery of the first ring that is distal from said first connection structure.

5. The resonant structure of claim 4, where, a sum of the radial length of any of the at least two second radial recesses and the radial length of any of the at least two third radial recesses is larger than the first radial thickness.

6. The resonant structure of claim 4, where at least two of the at least two second radial recesses are arranged each between the first radial recess and one of the at least two third radial recesses.

7. The resonant structure of claim 1, where said at least two coaxial rings comprise a second ring coaxially attached to the first ring by the first plurality of connection structures; and third and fourth coaxial rings attached together by a second plurality of connection structures being radially aligned each with a connection structure of the first plurality of connection structures; wherein the third ring has a third ring portion having a third radial thickness and has a fourth ring portion having a fourth radial thickness smaller than the third radial thickness; the fourth ring portion being radially aligned with the second ring portion; the fourth ring portion being formed by a third radial recess, developing from a periphery of the third ring distal from a second connection structure of the second plurality of connection structures toward the second connection structure;
wherein the third ring portion comprises at least two fourth radial recesses of identical radial lengths and arranged symmetrically with respect to the fourth ring portion, each of the at least two fourth radial recesses having at least a rectangular portion that develops radially from a periphery of the third ring that is in contact with the second connection structure; and wherein a sum of the radial length of the third radial recess and the radial length of any of the at least two fourth radial recesses is larger than the second radial thickness.

8. The resonant structure of claim 7, where one of the first and second rings is attached to one of the third and fourth rings by a plurality of regularly arranged third connection structures angularly offset from the first connection structures attaching the first and second rings.

9. The resonant structure of claim 1, where a same number N of connection structures attach each ring to a neighboring ring; and connection structures attached to an inner and an outer periphery of each ring are angularly offset by π/N from each other.

10. The resonant structure of claim 1, where said at least two coaxial rings comprise a second ring coaxially attached to the first ring by the first connection structure; wherein the second ring has a third ring portion having a third radial thickness and has a fourth ring portion having a fourth radial thickness smaller than the third radial thickness; the fourth ring portion being radially aligned with the second ring portion; the fourth ring portion being formed by a third radial recess developing from a periphery of the second ring distal from the first connection structure toward the first connection structure;
wherein the third ring portion comprises at least two fourth radial recesses of identical radial lengths and arranged symmetrically with respect to the fourth ring portion, each of the at least two fourth radial recesses having at least a rectangular portion that develops radially from a periphery of the second ring that is in contact with the first connection structure; and wherein a sum of the radial length of the third radial recess and the radial length of any of the at least two fourth radial recesses is larger than the second radial thickness.

11. The resonant structure of claim 1, where, the at least two coaxial rings comprise at least three coaxial rings, wherein a distance between two consecutive coaxial rings is constant.

12. The resonant structure of claim 1, where, the at least two coaxial rings comprises at least three coaxial rings, wherein a distance between two consecutive coaxial rings is varies radially.

13. The resonant structure of claim 1, where, the innermost of the at least two coaxial rings is attached, using connection structures similar to the connection structures attaching together said at least two coaxial rings, to a pillar having a same axis as the at least two coaxial rings.

14. The resonant structure of claim 1, where the at least two second radial recesses have each an angular width that is equal to a radial distance between the at least two adjacent rings.

15. The resonant structure of claim 1, where the first radial recess is optional, and the radial length of any of the at least two second radial recesses is smaller than the first radial thickness.

16. The resonant structure of claim 1, where the first radial recess and any of the at least two second radial recesses have a rounded end in a plane parallel to the plane of the rings.

17. The resonant structure of claim 1, where the outermost of the at least two coaxial rings comprises no first radial recess, so as to allow a stronger interaction between an outermost surface of the outermost ring and capacitive electrodes arranged at a distance of said outermost surface.

18. A disk resonator gyroscope using the resonant structure of claim 1.

19. A method of manufacturing a resonant structure comprising providing at least two coaxial rings, wherein: adjacent coaxial rings have adjacent peripheries and are attached together by a plurality of connection structures regularly arranged along the adjacent peripheries; and a first ring of said at least two rings has a first ring portion with a first radial thickness and a second ring portion, in a vicinity of a first connection structure, with a second radial thickness smaller than the first radial thickness; wherein the second ring portion is formed by a first radial recess developing from a periphery of the first ring distal from the first connection structure toward the first connection structure; wherein the first ring portion comprises at least two second radial recesses of identical radial lengths and arranged symmetrically with respect to the second ring portion, each of the at least two second radial recesses having at least a rectangular portion that develops radially from a periphery of the first ring that is in contact with the first connection structure; and wherein a sum of a radial length of the first radial recess and the radial length of any of the at least two second radial recesses is larger than the first radial thickness.
